(19) United States
(12) Patent Application Publication
(10) Pub. No.: US 2020/0166060 A1
(43) Pub. Date: May 28, 2020

(54) CONVEYING STRUCTURE CAPABLE OF INCREASING FLOW AMOUNT AND FLOW SPEED OF MICRO FLUID

(71) Applicant: Kuo-Lung LOR, New Taipei City (TW)

(72) Inventor: Kuo-Lung LOR, New Taipei City (TW)

(21) Appl. No.: 16/198,797

(22) Filed: Nov. 22, 2018

(51) Int. Cl. F15D 1/00

(52) U.S. Cl. CPC F15D 1/00

(57) ABSTRACT

Conveying structure capable of increasing flow amount and flow speed of micro fluid includes: at least one rolling wheel base, disposed with a rotation power device and a rolling wheel having plural convex columns; a micro flow passage panel, disposed below the rolling wheel base and composed of a top cover panel and a bottom passage panel formed with at least two flow passages which are not in communication and formed with an inlet passage and an outlet passage; and at least one membrane, arranged above a circular recessed seat formed on the bottom passage panel and disposed with a convex ring having the interior formed with a hollow chamber, wherein through the convex columns of the rolling wheel base conveying a fluid in the hollow chamber with a peristaltic means, the fluid is enabled to flow from the inlet passage towards the outlet passage of the flow passages.

### BACKGROUND OF THE INVENTION

### 1. Field of the Invention

The present invention relates to a conveying structure, especially to a conveying structure capable of increasing flow amount and flow speed of micro fluid, in which convex columns of a rolling wheel of a rolling wheel base allow a fluid in a hollow chamber of a membrane having a convex ring to be conveyed with a peristaltic means, so that the fluid is enabled to flow from an inlet passage towards an outlet passage of a flow passage of a micro flow passage panel.

### 2. Description of Related Art

N/A

### SUMMARY OF THE INVENTION

One primary objective of the present invention is to provide a conveying structure capable of increasing flow amount and flow speed of micro fluid, in which convex columns of a rolling wheel of a rolling wheel base allow a fluid in a hollow chamber of a membrane having a convex ring to be conveyed with a peristaltic means, so that the fluid is enabled to flow from an inlet passage towards an outlet passage of a flow passage of a micro flow passage panel, thereby overcoming the shortages existed in prior art.

Another objective of the present invention is to provide a conveying structure capable of increasing flow amount and flow speed of micro fluid having advantages of minimizing the pollution, increasing the flow amount and the flow speed, increasing the Reynolds number, and enabling the reaction between the turbulent flow and the bio-chip to be generated.

One another objective of the present invention is to provide a conveying structure capable of increasing flow amount and flow speed of micro fluid having an advantage of allowing the application to the bio-chip to be effectively increased, and advantages of convenient in use and precise operation are also provided.

The problem to be solved by the present invention is that: a bio-chip having a micro mixer with micro passages and an integrated detecting function is manufactured by a micro electromechanical system (MEMS), the micro mixer includes an acrylic layer, a silicon layer and a bottom layer, the acrylic layer is formed with the micro passages in a Y-like status, and the distal end heads are formed with at least two inlet holes allowing tubes to be inserted, an injecting pipette is utilized for injecting at least two liquids into the inlet holes, the tail end of the micro passage is formed with a discharge hole allowing the mixed liquid to be discharged and allowing a tube to be inserted, the silicon layer is arranged below the acrylic layer, the bottom layer is arranged below the silicon layer, the bottom layer is formed with a plurality of penetrated holes allowing a firing pin to be inserted and controlling the fluid corresponding to the micro passage, the plural penetrated holes are disposed with stop valves corresponding to the silicon layer and the micro passages of the acrylic layer for stopping the liquid.

Accordingly, the present invention provides a conveying structure capable of increasing flow amount and flow speed of micro fluid, which includes:

at least one rolling wheel base, disposed with a rotation power device, wherein the rotation power device is disposed with a rolling wheel having a plurality of convex columns, and the bottom end of each of the convex columns is formed with a distal end head;

a micro flow passage panel, disposed below the rolling wheel base and composed of a top cover panel and a bottom passage panel being engaged with each other, wherein the bottom passage panel is formed with at least two flow passages which are not in communication and formed with an inlet passage and an outlet passage, the bottom passage panel is additionally formed with a circular recessed seat and connected to end ports of the at least two flow passages formed with the inlet passage and the outlet passage; and

at least one membrane, arranged above the circular recessed seat of the bottom passage panel and disposed with a convex ring having the interior formed with a hollow chamber, wherein through the convex columns of the rolling wheel base conveying a fluid in the hollow chamber of the convex ring of the membrane with a peristaltic means, the fluid is enabled to flow from the inlet passage towards the outlet passage of the flow passages.

Preferably, according to the present invention, the convex columns of the rolling wheel of the rolling wheel base are arranged with a radiating means.

Preferably, according to the present invention, the distal end head of the convex column of the rolling wheel is formed in a semispherical status.

Preferably, according to the present invention, the hollow chamber in the convex ring of the membrane is formed in a circular status.

Furthermore, according to the present invention, the rotation power device includes a motor having a power wheel, and a connection member connected to the rolling wheel and the power wheel.

Furthermore, according to the present invention, the rotation power device includes a deceleration motor having a power wheel, and a connection member connected to the rolling wheel and the power wheel.

Preferably, according to the present invention, the rolling wheel of the rolling wheel base and the power wheel are pulleys or gears.

Preferably, according to the present invention, the connection member of the rotation power device is a belt or a chain.

Advantages achieved by the present invention compared to the prior art are as followings: through the convex columns of the rolling wheel of the rolling wheel base conveying the fluid in the hollow chamber of the convex ring of the membrane with the peristaltic means, the fluid is enabled to flow from the inlet passage to the outlet passage of the flow passages of the micro flow passage panel; so that pollution can be minimized, the flow amount and the flow speed can be increased, and the Reynolds number can be greater, the reaction between the turbulent flow and the bio-chip is able to be generated, thus the application to the bio-chip can be effectively increased, and advantages of convenient in use and precise operation are also provided.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective exploded view according to the present invention;

FIG. 2 is a perspective view showing the assembly according to the present invention;

FIG. 3 is a cross sectional view showing the assembly according to the present invention;

FIG. 4 is a schematic view showing the rolling wheel and the convex columns being rotated and operated with the membrane having the fluid therein and the bottom passage panel according to the present invention;

FIG. 5 is a perspective exploded view according to another embodiment of the present invention;

FIG. 6 is a perspective view showing the assembly according to another embodiment of the present invention; and

FIG. 7 is a schematic view showing the rolling wheel and the convex columns being rotated and operated with the membrane having the fluid therein and the bottom passage panel according to another embodiment of the present invention.

### DETAILED DESCRIPTION OF THE PREFERRED EMBODIMENT

Preferred embodiments of the present invention will be described with reference to the drawings.

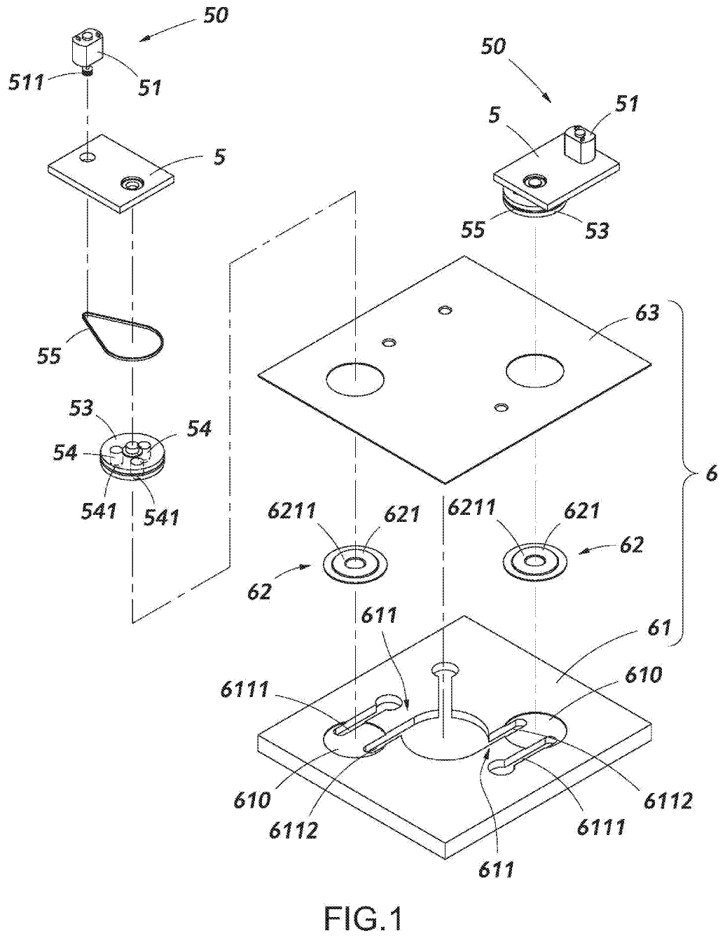

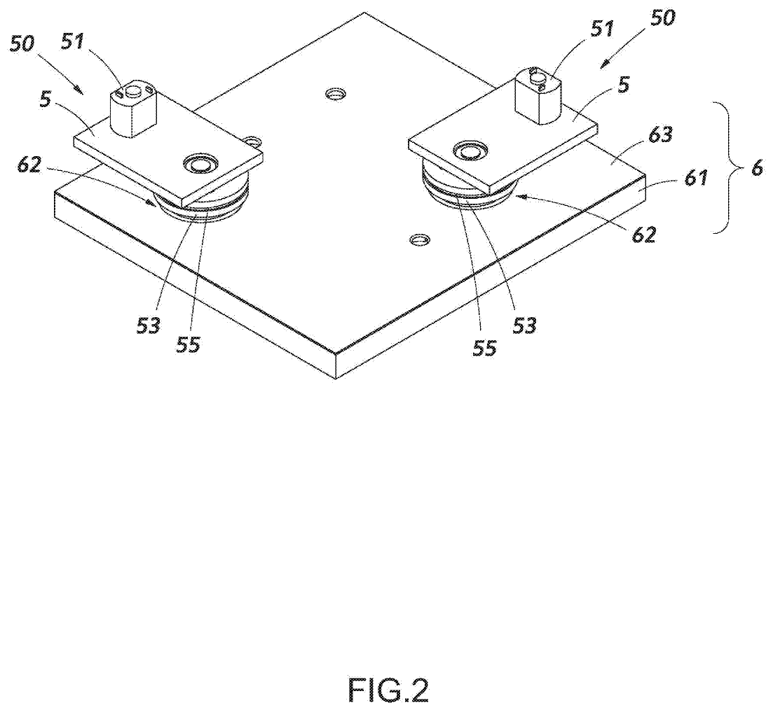

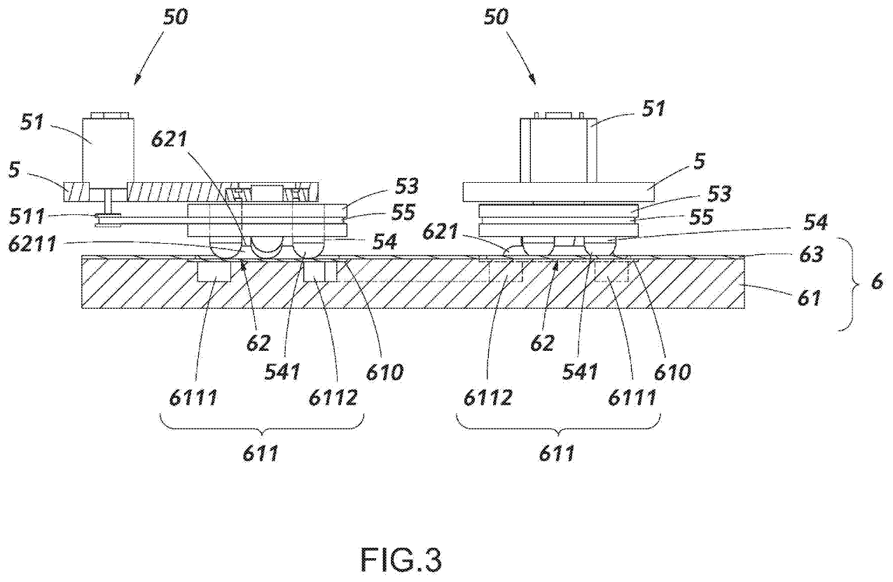

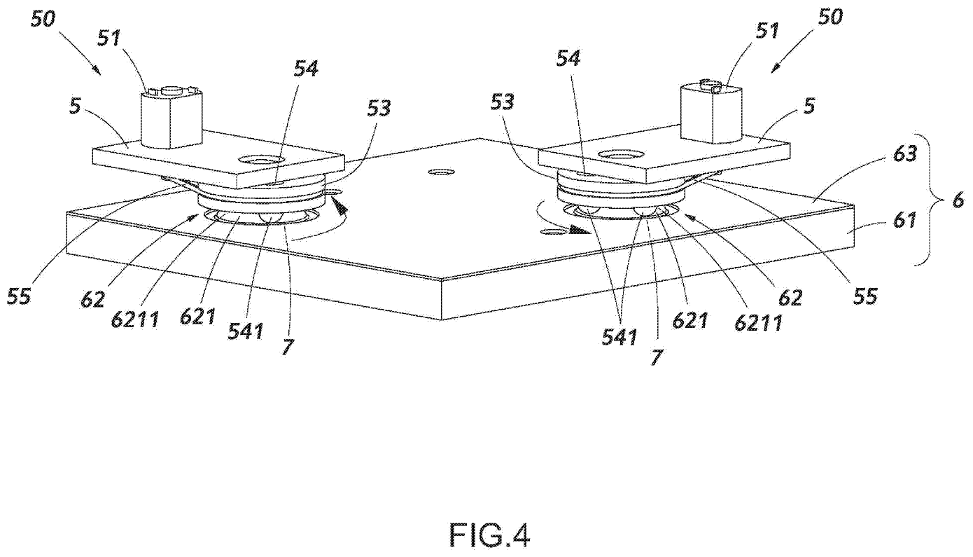

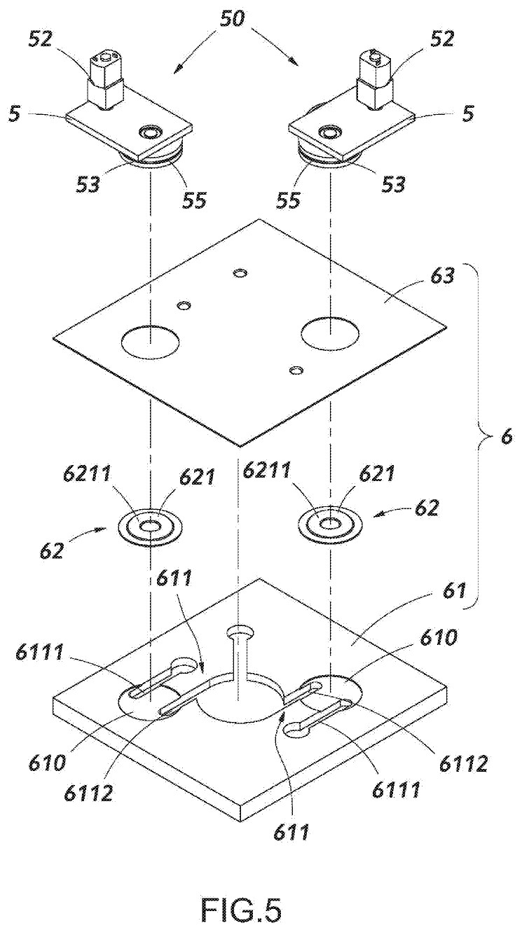

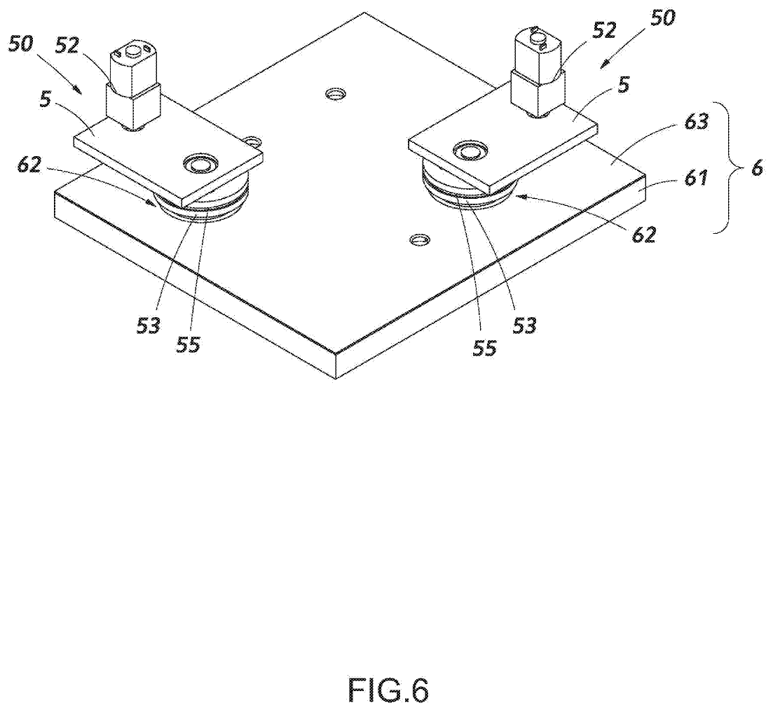

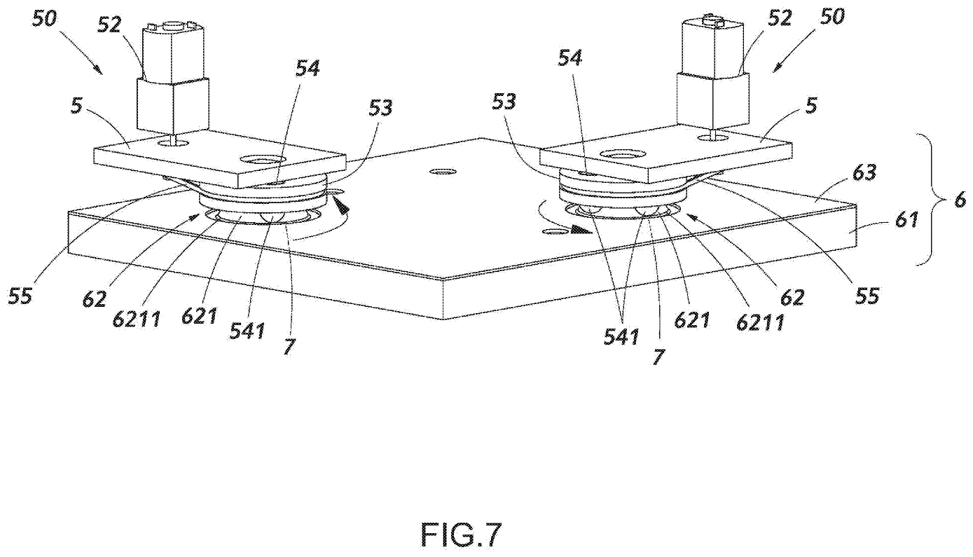

Referring from FIG. 1 to FIG. 7, wherein FIG. 1 is a perspective exploded view according to the present invention; FIG. 2 is a perspective view showing the assembly according to the present invention; FIG. 3 is a cross sectional view showing the assembly according to the present invention; FIG. 4 is a schematic view showing the rolling wheel and the convex columns being rotated and operated with the membrane having the fluid therein and the bottom passage panel according to the present invention; FIG. 5 is a perspective exploded view according to another embodiment of the present invention; FIG. 6 is a perspective view showing the assembly according to another embodiment of the present invention; and FIG. 7 is a schematic view showing the rolling wheel and the convex columns being rotated and operated with the membrane having the fluid therein and the bottom passage panel according to another embodiment of the present invention. According to one preferred embodiment of the present invention, the present invention provides a conveying structure capable of increasing flow amount and flow speed of micro fluid, which includes at least one rolling wheel base 5, a micro flow passage panel 6, and at least one membrane 62.

The at least one rolling wheel base 5 is disposed with a rotation power device 50, the rotation power device 50 is disposed with a rolling wheel 53 having a plurality of convex columns 54, the bottom end of each of the convex columns 54 is formed with a distal end head 541, according to this embodiment, the convex columns 54 of the rolling wheel 53 are arranged with a radiating means, and the distal end head 541 of the convex column 54 is formed in a semispherical status; the rotation power device 50 includes a motor 51 having a power wheel 511, a connection member 55 connected to the rolling wheel 53 and the power wheel 511 (as shown from FIG. 1 to FIG. 4), but what shall be addressed is that the scope of the present invention is not limited to the above-mentioned arrangement, the rotation power device 50 can also include a deceleration motor 52 having the power wheel 511, the connection member 55 connected to the rolling wheel 53 and the power wheel 511, so that the deceleration motor 52 can be utilized for increasing the torsion (as shown from FIG. 5 to FIG. 7); and as shown from FIG. 1 to FIG. 7, the rolling wheel 53 of the rolling wheel base 5 and the power wheel 511 are pulleys, but what shall be addressed is that the scope of the present invention is not limited to the above-mentioned pulleys, gears shall be within the scope of the present invention, the connection member 55 connected to the pulleys is a belt, the connection member 55 connected to the gears is a chain, the rolling wheel 53 and the power wheel 511 can be mutually matched by altering the diameters thereof so as to adjust the required torsion in actual use.

The micro flow passage panel 6 is disposed below the rolling wheel base 5, the micro flow passage panel 6 is composed of a top cover panel 63 and a bottom passage panel 61 being engaged with each other, the bottom passage panel 61 is formed with at least two flow passages 611 which are not in communication and formed with an inlet passage 6111 and an outlet passage 6112, the bottom passage panel 61 is additionally formed with a circular recessed seat 610 and connected to the end ports of the at least two flow passages 611 formed with the inlet passage 6111 and the outlet passage 6112.

The at least one membrane 62 is arranged above the circular recessed seat 610 of the bottom passage panel 61, and disposed with a convex ring 621 having the interior formed with a hollow chamber 6211, through the convex columns 54 of the rolling wheel base 5 conveying a fluid 7 in the hollow chamber 6211 of the convex ring 621 of the membrane 62 with a peristaltic means, the fluid 7 is enabled to flow from the inlet passage 6111 towards the outlet passage 6112 of the flow passages 611 (as shown in FIG. 4 and FIG. 7).

Advantages achieved by the present invention compared to the prior art are as followings: through the convex columns 54 of the rolling wheel 53 of the rolling wheel base 5 conveying the fluid 7 in the hollow chamber 6211 of the convex ring 621 of the membrane 62 with the peristaltic means, the fluid 7 is enabled to flow from the inlet passage 6111 towards the outlet passage 6112 of the flow passages 611 of the micro flow passage panel 6; so that pollution can be minimized, the flow amount and the flow speed can be increased, and the Reynolds number can be greater, the reaction between the turbulent flow and the bio-chip is able to be generated, thus the application to the bio-chip can be effectively increased, and advantages of convenient in use and precise operation are also provided. Accordingly, the conveying structure capable of increasing flow amount and flow speed of micro fluid provided by the present invention is novel and more practical in use compared to the prior art.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A conveying structure capable of increasing flow amount and flow speed of micro fluid, including:
at least one rolling wheel base, disposed with a rotation power device, wherein the rotation power device is disposed with a rolling wheel having a plurality of convex columns, and the bottom end of each of the convex columns is formed with a distal end head;
a micro flow passage panel, disposed below the rolling wheel base and composed of a top cover panel and a bottom passage panel being engaged with each other, wherein the bottom passage panel is formed with at least two flow passages which are not in communication and formed with an inlet passage and an outlet passage, the bottom passage panel is additionally formed with a circular recessed seat and connected to end ports of the at least two flow passages formed with the inlet passage and the outlet passage; and
at least one membrane, arranged above the circular recessed seat of the bottom passage panel and disposed with a convex ring having the interior formed with a hollow chamber, wherein through the convex columns of the rolling wheel base conveying a fluid in the hollow chamber of the convex ring of the membrane with a peristaltic means, the fluid is enabled to flow from the inlet passage towards the outlet passage of the flow passages.

2. The conveying structure capable of increasing flow amount and flow speed of micro fluid as claimed in claim 1, wherein the convex columns of the rolling wheel of the rolling wheel base are arranged with a radiating means.

3. The conveying structure capable of increasing flow amount and flow speed of micro fluid as claimed in claim 1, wherein the distal end head of the convex column of the rolling wheel is formed in a semispherical status.

4. The conveying structure capable of increasing flow amount and flow speed of micro fluid as claimed in claim 1, wherein the hollow chamber in the convex ring of the membrane is formed in a circular status.

5. The conveying structure capable of increasing flow amount and flow speed of micro fluid as claimed in claim 1, wherein the rotation power device includes a motor having a power wheel, and a connection member connected to the rolling wheel and the power wheel.

6. The conveying structure capable of increasing flow amount and flow speed of micro fluid as claimed in claim 1, wherein the rotation power device includes a deceleration motor having a power wheel, and a connection member connected to the rolling wheel and the power wheel.

7. The conveying structure capable of increasing flow amount and flow speed of micro fluid as claimed in claim 5, wherein the rolling wheel of the rolling wheel base and the power wheel are pulleys or gears.

8. The conveying structure capable of increasing flow amount and flow speed of micro fluid as claimed in claim 6, wherein the rolling wheel of the rolling wheel base and the power wheel are pulleys or gears.

9. The conveying structure capable of increasing flow amount and flow speed of micro fluid as claimed in claim 7, wherein the connection member of the rotation power device is a belt or a chain.

10. The conveying structure capable of increasing flow amount and flow speed of micro fluid as claimed in claim 8, wherein the connection member of the rotation power device is a belt or a chain.
